(19) United States
(12) Patent Application Publication
(10) Pub. No.: US 2024/0427538 A1
(43) Pub. Date: Dec. 26, 2024

(54) COMPUTER-READABLE STORAGE MEDIUM, INFORMATION PROCESSING DEVICE, AND METHOD FOR DISPLAYING WEB PAGE PROVIDED BY WEB SERVER EMBEDDED IN PRINTER

(71) Applicant: BROTHER KOGYO KABUSHIKI KAISHA, Nagoya (JP)

(72) Inventors: Kenju NARITA, Nagoya (JP); Yoshito HOSOMIZO, Konan (JP)

(21) Appl. No.: 18/824,026

(22) Filed: Sep. 4, 2024

Related U.S. Application Data
(63) Continuation of application No. PCT/JP2023/009282, filed on Mar. 10, 2023.

(30) Foreign Application Priority Data
Mar. 28, 2022 (JP) 2022-051092

(51) Int. Cl. G06F 3/12

(52) U.S. Cl. CPC G06F 3/1228; G06F 3/1205; G06F 3/1236; G06F 3/1253

(57) ABSTRACT

A non-transitory computer-readable storage medium stores computer-readable instructions that are executable by a computer of an information processing device and compatible with a particular printer. The instructions support a general-purpose print program incorporated in advance in an operating system of the information processing device and are configured to, when executed by the computer, cause the information processing device to, in response to receiving a processing request from the general-purpose print program when the operating system has accepted an instruction to activate the instructions with the particular printer selected, obtain connection information from the operating system, and perform, using the connection information, a display process to display a web page provided by a web server embedded in the particular printer. The connection information indicating a connection destination to which the particular printer is connected. The web server is configured to accept settings for the particular printer via the web page.

### REFERENCE TO RELATED APPLICATIONS

This application is a continuation of PCT International Application No. PCT/JP2023/009282 filed on Mar. 10, 2023, and claims priority from Japanese Patent Application No. 2022-051092 filed on Mar. 28, 2022, which are incorporated herein by reference in their entirety.

### BACKGROUND ART

In recent years, a technology has been put to practical use in which a printer is controlled by a general-purpose print program that is incorporated as standard into an operating system (hereinafter referred to as an “OS”) of an information processing device, without using a printer driver. In this technology, the OS associates the printer with the OS-standard general-purpose print program in response to detecting the printer, and thereafter, the information processing device is enabled to cause the printer to perform printing with the OS-standard general-purpose print program without using a printer driver in response to receiving a print instruction to the printer.

In addition, a printer has been known that incorporates an EWS (“EWS” is an abbreviation for “Embedded Web Server”), which is a program that functions as a web server and is configured to cause a browser of an information terminal to display a web page provided by the EWS and to accept various settings for the printer from the information terminal via the web page.

### SUMMARY

To cause the browser to display the web page provided by the EWS, it is required to enter an address of the printer, which is cumbersome for the user. In addition, for the known printer, a configuration has also been known in which an application program (e.g. a print application) provided by a printer vendor has a browser function and is configured to display the web page provided by the EWS. However, the print application needs to be activated to display the web page provided by the EWS. Even in an environment where an OS-standard general-purpose print program is used, the web page provided by EWS may be used to configure various settings for the printer, and there is room for improvement in a procedure for displaying the web page.

Aspects of the present disclosure are advantageous for providing one or more techniques for improving a procedure for an information processing device with an OS-standard general-purpose print program incorporated therein to display a web page provided by an EWS incorporated in a printer.

According to aspects of the present disclosure, a non-transitory computer-readable storage medium is provided, which stores computer-readable instructions that are executable by a computer of an information processing device and compatible with a particular printer. The computer-readable instructions support a general-purpose print program incorporated in advance in an operating system of the information processing device. The computer-readable instructions are configured to, when executed by the computer, cause the information processing device to, in response to receiving a request for processing from the general-purpose print program of the operating system when the operating system has accepted an activation instruction to activate the computer-readable instructions compatible with the particular printer with the particular printer selected, obtain connection information from the operating system. The connection information indicates a connection destination to which the particular printer is connected. The computer-readable instructions are further configured to, when executed by the computer, cause the information processing device to perform, using the obtained connection information, a display process to display a web page provided by a web server embedded in the particular printer. The web server is configured to accept settings for the particular printer via the web page.

According to aspects of the present disclosure, further provided is an information processing device that includes a display and a controller. The controller includes a computer and a non-transitory computer-readable storage medium. The non-transitory computer-readable storage medium stores a general-purpose print program incorporated in advance in an operating system of the information processing device. The non-transitory computer-readable storage medium further stores computer-readable instructions that are compatible with a particular printer and support the general-purpose print program. The computer-readable instructions are configured to, when executed by the computer, cause the controller to, in response to receiving a request for processing from the general-purpose print program of the operating system when the operating system has accepted an activation instruction to activate the computer-readable instructions compatible with the particular printer with the particular printer selected, obtain connection information from the operating system. The connection information indicates a connection destination to which the particular printer is connected. The computer-readable instructions are further configured to, when executed by the computer, cause the controller to perform, using the obtained connection information, a display process to display on the display a web page provided by a web server embedded in the particular printer. The web server is configured to accept settings for the particular printer via the web page.

According to aspects of the present disclosure, further provided is a method implementable by a computer executing computer-readable instructions on an information processing device. The computer-readable instructions are compatible with a particular printer and support a general-purpose print program incorporated in advance in an operating system of the information processing device. The method includes obtaining connection information from the operating system in response to receiving a request for processing from the general-purpose print program of the operating system when the operating system has accepted an activation instruction to activate the computer-readable instructions compatible with the particular printer with the particular printer selected. The connection information indicates a connection destination to which the particular printer is connected. The method further includes performing, using the obtained connection information, a display process to display on the display a web page provided by a web server embedded in the particular printer. The web server is configured to accept settings for the particular printer via the web page.

### BRIEF DESCRIPTION OF DRAWINGS

FIG. 1 is a block diagram schematically showing a configuration of a printing system.

FIG. 2 is a sequence diagram showing an example procedure for displaying a web page provided by an EWS incorporated in a printer and changing print settings for the printer in the printing system.

FIG. 3A shows an example of a “Bluetooth and Devices” screen.

FIG. 3B shows an example of a “Printers and Scanners” screen.

FIG. 4 shows an example of a printer screen.

FIG. 5 shows an example of a startup screen.

FIG. 6A shows an example of a web page screen.

FIG. 6B shows an example of a web page screen for print setting options.

FIG. 7 is a sequence diagram showing an example procedure of a comparison process based on operations by auxiliary programs.

FIG. 8 shows an example of a comparison result screen.

FIG. 9 shows an example of a setting check screen.

FIG. 10 is a sequence diagram showing an example procedure when a print execution instruction is accepted.

### DESCRIPTION

It is noted that various connections are set forth between elements in the following description. It is noted that these connections in general and, unless specified otherwise, may be direct or indirect and that this specification is not intended to be limiting in this respect. Aspects of the present disclosure may be implemented on circuits (such as application specific integrated circuits) or in computer software as programs storable on computer-readable media including but not limited to RAMs, ROMs, flash memories, EEPROMs, CD-media, DVD-media, temporary storage, hard disk drives, floppy drives, permanent storage, and the like.

In the present disclosure, an inclusive OR, meaning that it includes either A or B or both, may be expressed as “A and/or B,” “at least one of A or B,” or “at least one selected from the group consisting of A and B.” The same applies to a case where there are three or more selectable elements to consider.

A detailed explanation will be provided below of a printing system using a support program in an illustrative embodiment according to aspects of the present disclosure, with reference to the accompanying drawings.

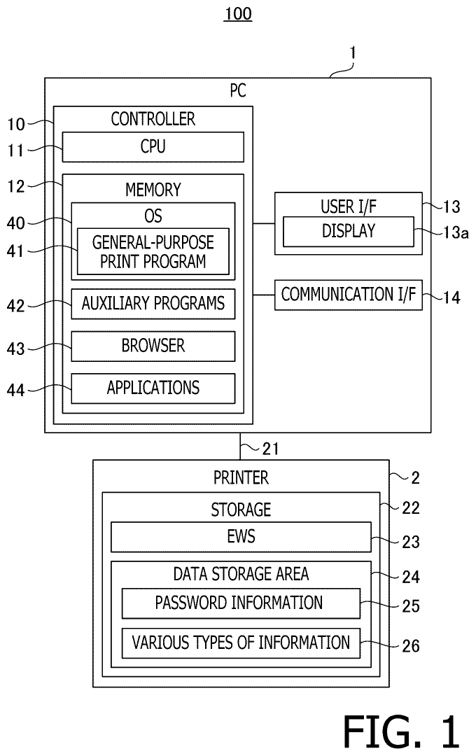

FIG. 1 schematically shows a configuration of a printing system 100 in the illustrative embodiment. As shown in FIG. 1, the printing system 100 includes a personal computer (hereinafter referred to as a “PC”) 1 and a printer 2.

As shown in FIG. 1, a PC 1 of the illustrative embodiment has a controller 10 that includes a CPU 11 and a memory 12. The PC 1 may be an example of an “information processing device” according to aspects of the present disclosure. The CPU 11 may be an example of a “computer” according to aspects of the present disclosure. The PC 1 further includes a user interface (hereinafter referred to as a “user I/F”) 13 and a communication interface (hereinafter referred to as a “communication I/F”) 14, which are electrically connected with the controller 10. The “controller 10” in FIG. 1 is a collective term for hardware and software used to control the PC 1, and may not necessarily represent a single hardware element actually existing in the PC 1.

The CPU 11 is configured to perform various processes according to programs read from the memory 12 and based on user operations. The memory 12 stores various types of data and various programs. The memory 12 is also used as a work area when various processes are performed. A buffer provided to the CPU 11 may be an example of a “memory” according to aspects of the present disclosure. Examples of the memory 12 are not limited to a ROM, a RAM, and an HDD that are incorporated in the PC 1, but may include storage media (e.g., CD-ROMs and DVD-ROMs) that are readable and writable by the CPU 11.

The user I/F 13 includes a display 13a that is hardware configured to display screens to provide information to the user, and hardware configured to receive user operations. The user I/F 13 may have a combination of the display 13a configured to display information, and a mouse and/or a keyboard that are configured to accept user input operations, i.e., having an input acceptance function. The user I/F 13 may include a touch panel having the display 13a and the input acceptance function.

The communication I/F 14 includes hardware configured to communicate with external devices such as the printer 2. Communication standards applicable for the communication I/F 14 include Ethernet (“Ethernet” is a registered trademark of Fuji Xerox Co., Ltd.), Wi-Fi (“Wi-Fi” is a registered trademark of the non-profit Wi-Fi Alliance), and USB. The PC 1 may be configured to connect with the Internet (not shown) via the communication I/F 14. The PC 1 may have a plurality of communication I/Fs 14 conforming to a plurality of communication standards.

As shown in FIG. 1, the memory 12 of the PC 1 stores an operating system (hereinafter referred to as an “OS”) 40 that includes a general-purpose print program 41, auxiliary programs 42, a browser 43, and various application programs (hereinafter referred to as “applications”) 44. Examples of the OS 40 may include, but are not limited to, Windows (“Windows” is a registered trademark of Microsoft Corporation), macOS (“macOS” is a registered trademark of Apple Inc.), Linux (“Linux” is a registered trademark of Linus Torvalds), iOS (“iOS” is a registered trademark of Cisco Systems, Inc.), and Android (“Android” is a registered trademark of Google LLC). The auxiliary programs 42 may be an example of the “support program” according to aspects of the present disclosure, and may be an example of “computer-readable instructions” according to aspects of the present disclosure.

The general-purpose print program 41 is an OS-standard program provided with the OS 40 and has a function to cause the printer 2 to print information that is displayed on the display 13a by the browser 43 or the applications 44. The general-purpose print program 41 in the illustrative embodiment is a program having a function for generating intermediate image data based on image data to be printed. The general-purpose print program 41 supports functions that are usable in common by a plurality of printer models provided by vendor(s) of various printers. Unlike printer drivers that are specific to individual printers, the general-purpose print program 41 does not support all of the functions that are unique to the individual printers. Functions supportable by the general-purpose print program 41 are limited to generic functions.

The auxiliary programs 42 include one program or a group of programs configured to, when executed by the CPU 11, cause the PC 1 to perform processing based on instructions from the OS 40, accompanying processing by the general-purpose print program 41. The auxiliary programs 42 include one or more programs that support control of target hardware elements. The auxiliary programs 42 in the illustrative embodiment are compatible with a model of the printer 2 connected with the PC 1. The auxiliary programs 42 are launched from the general-purpose print program 41, for instance, when the PC 1 has received an instruction to cause the printer 2 to perform printing using the general-purpose print program 41. The auxiliary programs 42 are called, for instance, PSA (“PSA” is an abbreviation for “Print Support Application”) or HSA (“HAS” is an abbreviation for “Hardware Support Application”).

For instance, the auxiliary programs 42 may include a combination of a plurality of programs each of which is configured to, when executed by the CPU 11, cause the PC 1 to accept execution instructions. In another instance, the auxiliary programs 42 may include one program configured to, when executed by the CPU 11, cause the PC 1 to accept instructions and perform respective different processes according to the accepted instructions. The auxiliary programs 42 may include a program prepared for each type of printer by the printer vendor(s). For instance, the auxiliary programs 42 may include an auxiliary program prepared for inkjet printers and an auxiliary program prepared for laser printers. The auxiliary programs 42 may include not only the auxiliary program prepared for each type of printer but also an auxiliary program prepared for each model of printer or an auxiliary program prepared for each series of models of printers.

For instance, when a new printer is connected with the PC 1, the OS 40 may cause the PC 1 to download an appropriate auxiliary program (e.g., the auxiliary programs 42) from a server or another source depending on a type of the connected printer and to incorporate the downloaded auxiliary program into the PC 1. Then, the OS 40 may cause the PC 1 to store identification information of the incorporated auxiliary program in the memory 12 in association with printer information of the newly connected printer.

The browser 43 is a program used to browse websites. The browser 43 is configured to, when activated, e.g., by an employee (a user), display on the display 13a a web page provided by a web server (e.g., in the illustrative embodiment, an after-mentioned EWS 23 of the printer 2) indicated by a specified URL. In the illustrative embodiment, the browser 43 is configured separately from the auxiliary programs 42. Therefore, the auxiliary programs 42 do not need to support a browser function to display the web page provided by the EWS 23, which facilitates the implementation of the auxiliary programs 42.

In the illustrative embodiment, the browser 43 is configured separately from the auxiliary programs 42. However, the auxiliary programs 42 may have a browser function. In this case, it is not necessary to activate a browser to display a web page, and even information processing device without a browser incorporated may access a web server to display a web page.

Examples of the applications 44 incorporated in the PC 1 in the illustrative embodiment may include, but are not limited to, an information application and an office application. Examples of the information application may include, but are not limited to, a map application, and a calendar application. The information application is configured to, when activated, e.g., by an employee (a user), display various types of information on the display 13a in response to user's requests. It is noted that the browser 43 may be incorporated in the information application. The information application itself may or may not have a function to cause a printer to print the displayed information.

Examples of the office application may include, but are not limited to, a word processing application, a spreadsheet application, and a presentation application. The office application is configured to, when activated, e.g., by an employee (a user), accept via the user I/F 13 various types of input such as image data representing an image, edits to the image, print settings, designation of a printer to perform printing, and a print execution instruction.

As shown in FIG. 1, the printer 2 is connected with the PC 1 in the illustrative embodiment. The printer 2 includes a controller, an image forming engine, a network interface (none of which is shown), and a storage 22. In the illustrative embodiment, the image forming method of the image forming section is a thermal printing method. Nonetheless, any of other methods such as an electrophotographic printing method and an inkjet printing method may be employed as the image forming method of the image forming engine. In addition, the image forming method of the image forming engine may support color printing or may support only monochrome printing. For instance, the communication standard for the network interface of the printer 2 is Ethernet. The network interface of the printer 2 is connected with the communication I/F14 of the PC 1 via a wired LAN 21. Practicable examples of the communication standard for the network interface of the printer 2 may include, but are not limited to, a wireless LAN communication standard such as Wi-Fi (“Wi-Fi” is a registered trademark of the non-profit Wi-Fi Alliance) and a USB communication standard.

The storage 22 of the printer 2 stores a program for an EWS (“EWS” is an abbreviation for “Embedded Web Server”) 23. The storage 22 has a data storage area 24 to store password information 25 and various types of information 26. The printer 2 is enabled to activate the EWS 23 by launching and executing the program for the EWS 23.

The password information 25 is information on a password for authentication that is used to log in to the EWS 23. The user is allowed to control the EWS 23 from the PC 1 if a password entered via the PC 1 matches the password indicated by the password information 25. The various types of information 26 include, for instance, capability information of the printer 2, connection information for connecting to the printer 2, status information of the printer 2, information on various settings configured for the printer 2, information on remaining consumables for the printer 2, information on the number of sheets printed by the printer 2, and information on consumable support.

Therefore, in the illustrative embodiment, the user is allowed to manage the printer 2 on the PC 1 by accessing the EWS 23 of the printer 2 via the browser 43 of the PC 1, displaying the web page provided by the EWS 23, and entering parameters.

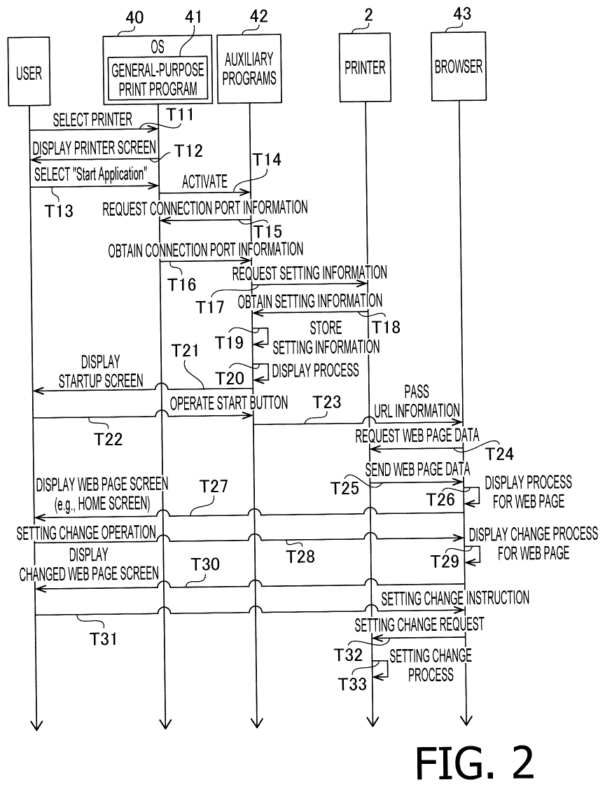

Subsequently, an example procedure for displaying the web page provided by the EWS 23 and changing print settings, including operations by the OS 40, the auxiliary programs 42, and browser 43, in the illustrative embodiment will be described with reference to a sequence diagram in FIG. 2. FIG. 2 and after-mentioned other sequence diagrams show operations and processes when the auxiliary programs 42 compatible with the printer 2 are incorporated in the PC 1.

Each processing step in the illustrative embodiment generally indicates processing by the CPU 11 primarily in accordance with instructions described in the auxiliary programs 42 and other programs. The processing by the CPU 11 includes hardware control using an API (“API” is an abbreviation for “Application Programming Interface”) of the OS 40. In the present disclosure, operations and processes by individual programs are described without a detailed description of the OS 40.

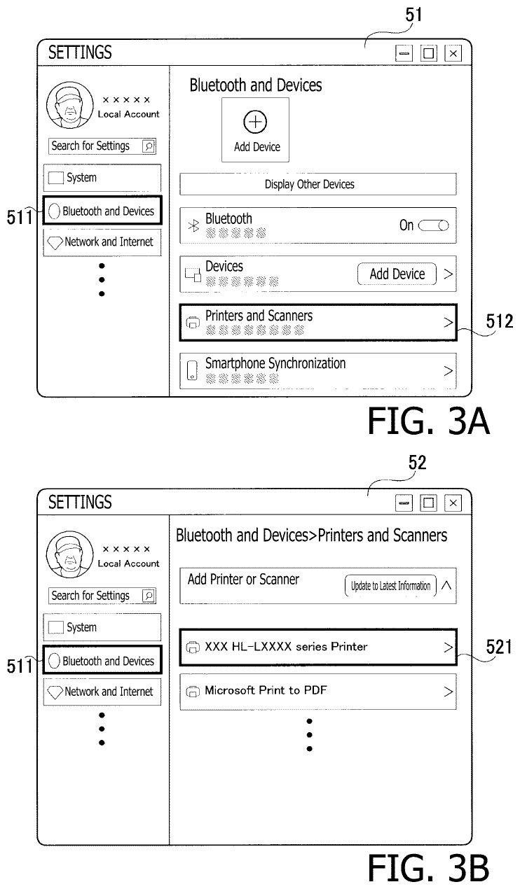

At the beginning of the procedure, for instance, when the user has clicked a start menu (not shown) on a start screen (not shown) of the OS 40 that is displayed on the display 13a, via the user I/F 13, the OS 40 causes the display 13a to display a start menu screen (not shown). When the user has then clicked a “Settings” button (not shown) on the start menu screen displayed on the display 13a via the user I/F 13, the OS 40 causes the display 13a to display a setting screen (not shown). Thereafter, when the user has clicked the “Bluetooth and Devices” button 511 from a menu displayed on the setting screen via the user I/F 13, the OS 40 causes the display 13a to display a “Bluetooth and Devices” screen 51, e.g., as shown in FIG. 3A.

Afterward, when the user has clicked a “Printers and Scanners” button 512 on the “Bluetooth and Devices” screen 51 displayed on the display 13a via the user I/F 13, the OS 40 causes the display 13a to display a “Printers and Scanners” screen 52, e.g., as shown in FIG. 3B. For instance, as shown in FIG. 3B, on the “Printers and Scanners” screen 52, respective printer selection buttons associated with individual printers are listed, and the list includes a printer selection button 521 associated with the printer 2. Specifically, each printer selection button is associated with a printer queue managed by the OS 40, and an individual printer queue is generated for each printer by the OS 40.

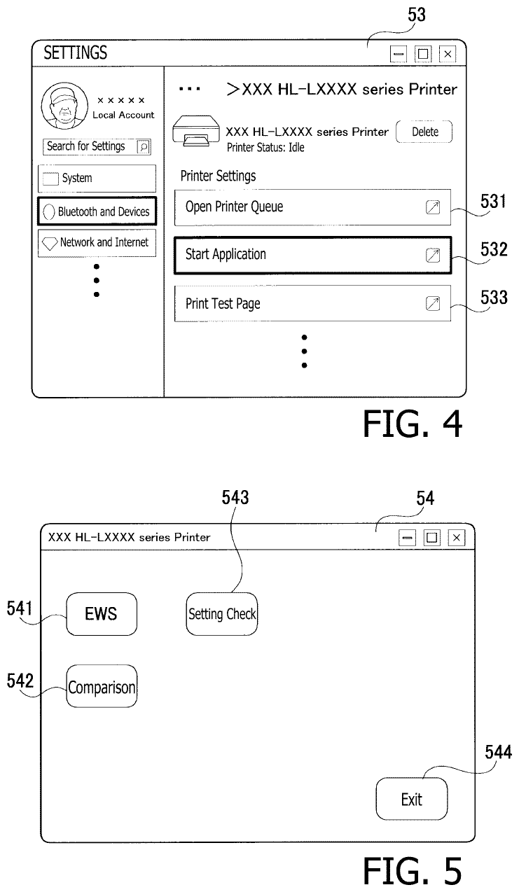

When the user has then clicked the printer selection button 521 on the “Printers and Scanners” screen 52 via the user I/F 13 (T11 in FIG. 2), the OS 40 causes the display 13a to display a printer screen 53 for the printer 2 that is associated with the printer selection button 521, e.g., as shown in FIG. 4 (T12). For instance, the printer screen 53 includes operable buttons displayed thereon, such as an “Open Printer Queue” button 531, a “Start Application” button 532, and a “Print Test Page” button 533.

Thereafter, when the user has clicked the “Start Application” button 532 displayed on the printer screen 53 via user I/F 13 (T13), the general-purpose print program 41 of the OS 40 activates the auxiliary programs 42 compatible with the currently selected printer 2 (T14).

The OS 40 stores printer information and program identification information in the memory 12 in association with each other. When the printer information of the selected printer is associated with the printer identification information of a program, the general-purpose print program 41 activates the program identified by the associated printer identification information in response to a click operation on the “Start Application” button 532. The printer information of a printer and the program identification information of a program are associated with each other, for instance, when the print queue is generated, or when the program is installed. In the illustrative embodiment, the printer information of the printer 2 is associated with the identification information of the auxiliary programs 42. In response to a click operation on the “Start Application” button 532 with the printer 2 selected, the general-purpose print program 41 activates the auxiliary programs 42.

When activated from the general-purpose print program 41 of the OS 40 in response to the click operation on the “Start Application” button 532, the auxiliary programs 42 send a request for connection port information of the printer 2 to the OS 40 (T15). In response to receiving the request for the connection port information, the OS 40 sends the connection port information to the auxiliary programs 42. Thus, the auxiliary programs 42 obtain the connection port information (T16).

In the illustrative embodiment, the PC 1 and the printer 2 are connected with each other via the wired LAN 21. Therefore, the auxiliary programs 42 obtain, as the connection port information, port information of a port connected with the wired LAN 21 and an IP address of the printer 2. When the PC 1 and the printer 2 are connected with each other via a USB, the auxiliary programs 42 obtain, as the connection port information, port information of a port assigned to the USB and the IP address of the printer 2.

Then, based on the obtained connection port information, the auxiliary programs 42 send a request to send setting information to the printer 2, for instance, using an MIB (“MIB” is an abbreviation for “Management Information Base”) (T17). In response to receiving the request to send the setting information, the printer 2 extracts the setting information of the printer 2 from the various types of information 26 in the memory 22, and sends the extracted setting information to the PC 1. Thus, the auxiliary programs 42 obtain the setting information (T18), and then store the obtained setting information currently set for the printer 2 in the memory 12 (T19).

In the illustrative embodiment, the auxiliary programs 42 are configured to obtain the setting information directly from the printer 2, for instance, using the MIB. However, practicable examples are not limited to such a configuration. For instance, the auxiliary programs 42 may be configured to obtain the setting information via the general-purpose print program 41 of the OS 40. In this case, the auxiliary programs 42 send a request for the capability information to the general-purpose print program 42. In response to the request, the general-purpose print program 41 sends a request for the capability information to the printer 2 using an IPP (“IPP” is an abbreviation for “Internet Printing Protocol”). In response to the request form the general-purpose print program 41, the printer 2 sends the capability information including the setting information of the printer 2 to the general-purpose print program 41. The general-purpose print program 41 then passes the capability information received from the printer 2 to the auxiliary programs 42. In this case, auxiliary programs 42 obtain the setting information of the printer 2 indirectly via the OS 40 and do not need to perform the process of T17 to T18.

In the illustrative embodiment, the setting information of the printer 2 may include, but are not limited to, at least one selected from a sheet type, print quality, a sheet size, a color mode, a print orientation, and sheet stain reduction.

Afterward, the auxiliary programs 42 perform a display process to display a startup screen (T20), and then cause the display 13a to display a startup screen 54, e.g., as shown in FIG. 5 (T21). The startup screen 54 includes operable buttons displayed thereon such as a start button 541 for displaying the EWS 23, a comparison button 542 for performing an after-mentioned comparison process, a setting check button 543 for checking settings, and an exit button 544. When the user has clicked the exit button 544 via the user I/F 13, the PC 1 stops displaying the startup screen 54. The setting check button 543 is displayed in such a manner as to be inoperative (e.g., hidden or grayed out) until the start button 541 is clicked.

When the user has clicked the start button 541 for accessing the EWS via the user I/F 13 while the startup screen 54 shown in FIG. 5 is being displayed on the display 13a (T22), the auxiliary programs 42 pass to the browser 43 URL information of the EWS 23 that is based on the IP address, obtained in T16, of the printer 2 (T23). If the browser 43 has not been activated, the auxiliary programs 42 also activate the browser 43 in T23. Once the URL information is passed to the browser 43, the browser 43 accesses the EWS 23 to make a request for web page data based on the obtained URL information (T24). The browser 43 then receives web page data of a login screen from the EWS 23 and displays the login screen. If a password entered into the browser 43 via the login screen matches the password indicated by the password information 25 stored in the printer 2, the browser 43 successfully logs in to the EWS 23 and receives web page data of setting screens from the EWS 23 (T25). Thus, in the illustrative embodiment, the browser 43 accesses the EWS 23 after waiting until the start button 541 is operated in T22.

In the illustrative embodiment, the printing system 100 is configured in such a manner that the browser 43 accesses the EWS 23 after waiting until the start button 541 is operated. However, the printing system 100 may be configured in such a manner that the browser 43 accesses the EWS 23 without waiting until the start button 541 is operated. In this case, it is possible to save time and effort for operating the start button 541 to access the EWS 23. Furthermore, in the illustrative embodiment, the start button 541 is configured to be displayed on the startup screen 54. However, practicable examples are not limited to this configuration. Specifically, for instance, the start button 541 may be configured to be displayed on a dedicated screen such as a pop-up screen that appears in front of the startup screen 54.

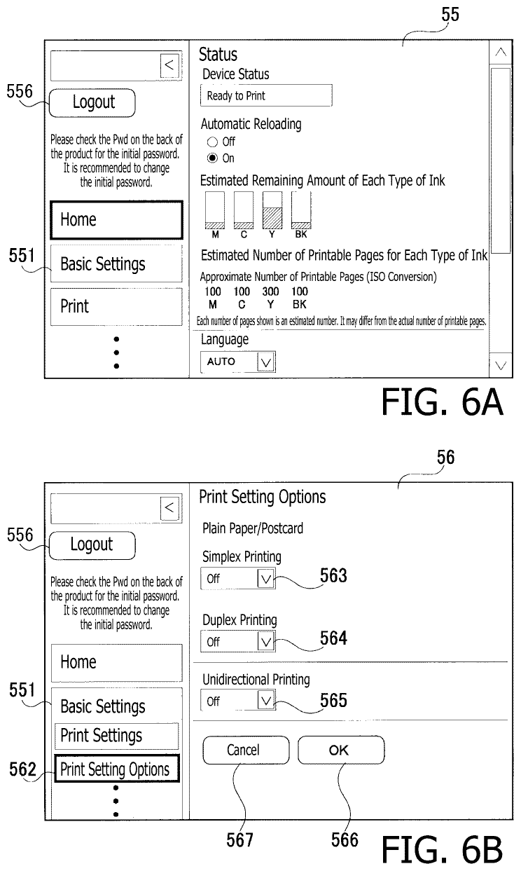

Thereafter, the browser 43 performs a display process to display a web page based on the received web page data of the setting screens (T26), and then causes the display 13a to display a home screen 55 of the setting screens as shown in FIG. 6A (T27).

In the illustrative embodiment, a status of the printer 2 is displayed on the home screen 55. Therefore, the user may know a current status of the printer 2 by viewing the home screen 55 displayed on the display 13a.

Namely, in the illustrative embodiment, when the user has clicked the start button 541 to activate the EWS 23 via the user I/F 13 (T22), a setting screen such as the home screen 55 shown in FIG. 6A is displayed on the display 13a (T27). This allows the user to accurately grasp the current status and settings of the printer 2, thereby improving user convenience.

In the illustrative embodiment, unless the user clicks the start button 541 to activate the EWS 23 via the user I/F 13, the EWS 23 is not accessed, and the home screen 55 is not displayed on the user I/F 13. Therefore, if there is no need to display a web page, the user need only not operate the start button 541. Thus, it is possible to avoid unnecessary display by not displaying a web page of the EWS 23.

When the user performs a setting change operation to change the print settings via user I/F13 on the web page screen displayed on the browser 43 (T28), the browser 43 performs a display change process to update the contents displayed on the web page screen based on an instruction corresponding to the user's setting change operation (T29), and displays a changed web page screen on the display 13a (T30).

Specifically, in the illustrative embodiment, when the user has clicked a “Basic Settings” button 551 in a left menu on the home screen 55 shown in FIG. 6A via the user I/F 13, the browser 43 displays a basic setting screen (not shown) on the display 13a. Then, when the user has further clicked on a “Print Setting Options” button 562 in a left menu on the basic setting screen, the browser 43 causes the display 13a to display a setting screen 56 for print setting options as shown in FIG. 6B based on an instruction corresponding to the click operation on the “Print Setting Options” button 562.

Thus, in the illustrative embodiment, the browser 43 displays the contents of the print settings for the printer 2 connected with the PC 1 on the display 13a, thereby allowing the user to check whether the print settings configured for the printer 2 are set correctly via the setting screen 56 for print setting options.

On the setting screen 56 for print setting options, for instance, for a sheet stain reduction function, one of the stain reduction levels “Off,” “Low,” and “High” is settable for each of simplex printing and duplex printing. Furthermore, for a unidirectional printing function, one of “Off” and “On” is settable.

To be more specific about the sheet stain reduction function, in the printer 2, depending on contents printed on the front side of a sheet, ink may not dry easily, causing the back side of the sheet to be stained. Therefore, in the sheet stain reduction function of the printer 2, when the user sets the stain reduction level to “Low,” the printer 2 performs printing on the sheet at a lower speed and with a normal amount of ink to reduce sheet stains. When the user sets the stain reduction level to “High,” the printer 2 performs printing on the sheet at the lower speed and with a smaller amount of ink to reduce sheet stains. When the user sets the stain reduction level to “Off,” the printer 2 performs printing on the sheet at a normal speed and with the normal amount of ink. The setting of the sheet stain reduction level may be changed by the user clicking one of “Off,” “Low,” and “High” from a drop-down list in each of the pull-down menus 563 and 564 displayed on the display 13a (T28).

In the unidirectional printing function of the printer 2, when the user sets a setting parameter for the function to “Off,” the printer 2 performs printing on the sheet in a bidirectional manner, which increases the printing speed. When the user sets the setting parameter for the function to “On,” the printer 2 performs printing on the sheet in a unidirectional manner, which reduces the printing speed but improves the print quality. The setting for the unidirectional printing function may be configured by the user clicking one of “Off” and “On” from a drop-down list in a pull-down menu 565 displayed on the display 13a (T28).

The web page screen 56 for print setting options (see FIG. 6B) shows an initial state of the print settings. In the illustrative embodiment, the following explanation will be provided under an assumption that the user has changed the settings on the setting screen 56 for print setting options shown in FIG. 6B from an initial setting of “Off” to “Low” for the stain reduction level for simplex printing, and from an initial setting of “Off” to “High” for the strain reduction level for duplex printing. For unidirectional printing, it is assumed that the setting has not been changed from an initial setting of “Off.”

Accordingly, the browser 43 performs the display change process to update the contents displayed on the setting screen 56 for print setting options based on the user's setting change operations (T29). Thereafter, the browser 43 causes the display 13a to display the updated contents of the setting screen 56 for print setting options after the display change process.

The user may provide a setting change instruction to change the print settings to the browser 43 by clicking an “OK” button 566 on the setting screen 56 for print setting options shown in FIG. 6B via the user I/F 13 (T31). If the user clicks a “Cancel” button 567 via the user I/F 13, the setting change instruction will not be provided to the browser 43.

In response to receiving the setting change instruction to change the print settings, the browser 43 sends to the printer 2 information indicating that the setting change instruction has been received (T32). In response to receiving the information, the printer 2 changes the print settings (T33). In the illustrative embodiment, for the sheet stain reduction function, the stain reduction level for simplex printing is changed from “Off” to “Low,” and the stain reduction level for duplex printing is changed from “Off” to “High.”

When the user has clicked a “Logout” button 556 on the home screen 55 shown in FIG. 6A or on the setting screen 56 for print setting options shown in FIG. 6B via the user I/F 13, information indicating that a logout instruction has been received is sent to the printer 2. Thus, the EWS 23 is instructed to allow the user of the PC 1 to log out of the EWS 23.

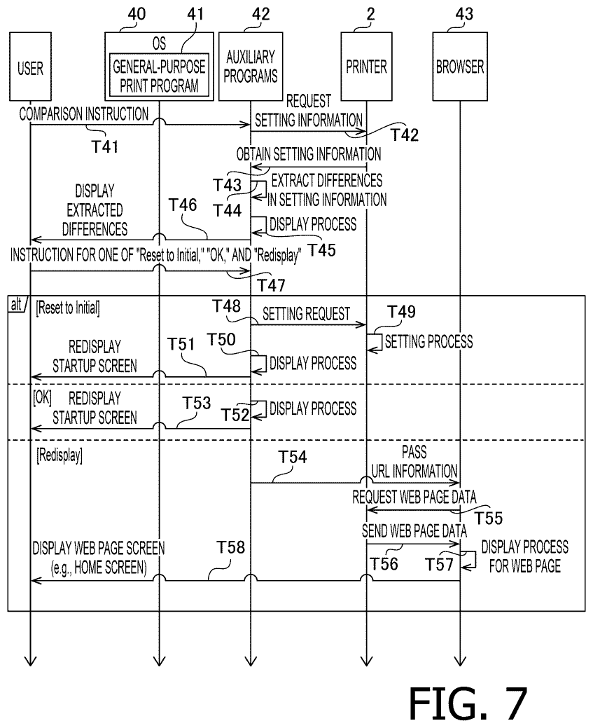

Subsequently, an example procedure of a comparison process based on operations by the auxiliary programs 42 in the illustrative embodiment will be described with reference to a sequence diagram shown in FIG. 7.

When the user has clicked via the user I/F 13 the comparison button 542 for starting the comparison process on the startup screen 54 displayed on the display 13a (T41), the auxiliary programs 42 send to the printer 2 a request to send the setting information, based on the connection port information obtained in T16 (T42). In response to receiving the request, the printer 2 extracts the setting information of the printer 2 from the various types of information 26 in the storage 22 and sends the extracted setting information to the PC 1. Thus, the auxiliary programs 42 obtain the setting information (T43). The process of T42 to T43 is substantially the same as that of T17 to T18.

Thus, in the illustrative embodiment, the comparison process to compare the print settings is started in response to the comparison button 542 being clicked. Users who do not require the comparison of the print settings may find the display of comparison results annoying and frustrating. Therefore, in the illustrative embodiment, the comparison process to compare the print settings is performed in response to acceptance of the click operation on the comparison button 542 before the comparison of the print settings. Thus, it is possible to eliminate the frustration of the users who do not require the comparison of the print settings.

Next, the auxiliary programs 42 compare the setting information obtained from the printer 2 in T43 with the initial setting information stored in the memory 12 in T19, and extract differences in the setting information. Namely, the auxiliary programs 42 extract print settings that have been changed from the initial print settings (T44).

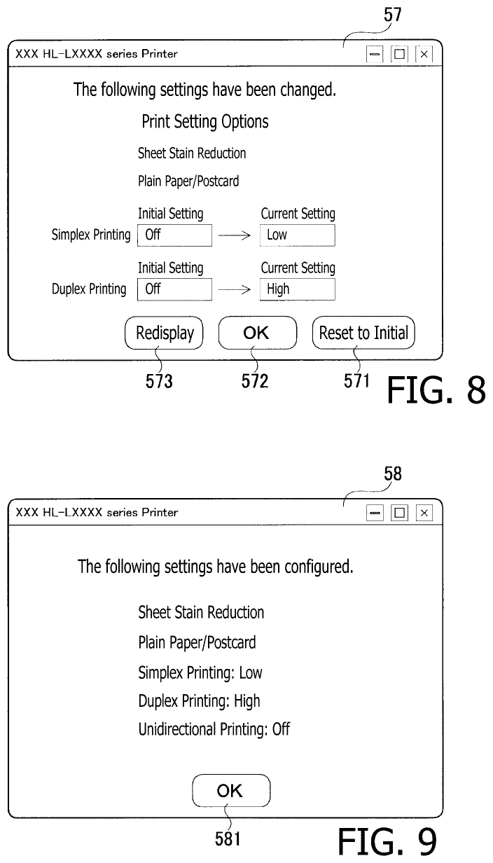

Next, the auxiliary programs 42 performs a display process to display the extracted differences in the setting information (T45), and display a comparison result screen 57 as shown in FIG. 8 on the display 13a (T46).

When the user has provided the setting change instruction to change the print settings to the browser 43 in T31, the comparison result screen 57 shown in FIG. 8 displays differences between the initial settings and the current settings for the changed print settings. For instance, in the illustrative embodiment, for the sheet stain reduction function, the comparison result screen 57 displays thereon the initial setting “Off” and the current setting “Low” for simplex printing, and the initial setting “Off” and the current setting “High” for duplex printing. In this case, since the setting for the unidirectional printing function is not changed, no difference from the initial setting for the unidirectional printing function is displayed on the comparison result screen 57. Further, the comparison result screen 57 includes a “Reset to Initial” button 571, an “OK” button 572, and a “Redisplay” button 573 displayed thereon.

Thus, in the illustrative embodiment, the auxiliary programs 42 cause the display 13a to display the settings (i.e., the changed print settings) that are considered to be differences from the initial print settings among the print settings for the printer 2 when the comparison with the initial print settings is made. Thereby, the user is allowed to check whether the changed print settings are set correctly via the comparison result screen 57 displayed on the display 13a. In addition, since only the changed print settings are displayed, it is easier to understand which settings have been changed from the initial print settings than when all the print settings are displayed.

Next, the user clicks one of the “Reset to Initial” button 571, the “OK” button 572, and the Redisplay” button 573 on the comparison result screen 57 via the user I/F 13, thereby providing an instruction corresponding to the clicked one of the buttons 571, 572, and 573 (T47). Then, if the user clicks the “Reset to Initial” button 571 to provide the instruction corresponding to the clicked button 571, the auxiliary programs 42 send to the printer 2 a setting request command to configure the print settings for the printer 2 the printer 2, in association with the initial setting information stored in the memory 12 (T48). Accordingly, the printer 2 performs a setting process to reset the changed print settings to the initial print settings based on the received setting information (T49). Thereafter. the auxiliary programs 42 perform a display process to cause the user I/F 13 to redisplay the startup screen 54 (T50), and then cause the user I/F 13 to redisplay the startup screen 54 shown in FIG. 5 (T51).

Thus, in the illustrative embodiment, in response to receiving the instruction to reset the changed print settings to the initial print settings, the auxiliary programs 42 send to the printer 2 the command to change the changed print settings to the print settings before the change. Thus, since the print settings changed via the web page of the EWS 23 are canceled and reset to the initial print settings, it is possible to avoid operation with incorrect setting changes.

If the user clicks the “OK” button 572 to provide the instruction corresponding to the clicked button 572 in T47, the auxiliary programs 42 perform a display process to cause the user I/F 13 to redisplay the startup screen 54 (T52) without sending a setting request command to the printer 2, and then cause the user I/F 13 to redisplay the startup screen 54 shown in FIG. 5 (T53).

If the user clicks the “Redisplay” button 573 to provide the instruction corresponding to the clicked button 573 in T47, the auxiliary programs 42 pass the URL information of the EWS 23 again to the browser 43 (T54). The browser 43 then accesses the EWS 23 of the printer 2 and makes a request for the web page data based on the obtained URL information (T55). The printer 2 then sends the web page data to the browser 43 (T56). Thereafter, the browser 43 performs a display process to display the web page based on the received web page data (T57), and then causes the display 13a to redisplay the home screen 55 shown in FIG. 6A (T58). Thus, the user may reconfigure the print settings for the printer 2 by clicking the “Basic Settings” button 551 in the left menu on the home screen 55 via the user I/F 13.

Thus, in the illustrative embodiment, when the “Redisplay” button 573 is clicked, the auxiliary programs 42 pass the URL information to the browser 43 again. This allows the user to reconfigure the print settings via the web page redisplayed. Thus, it is possible to avoid operation with incorrect setting changes.

When the user has clicked the start button 541 on the startup screen 54 displayed on the display 13a, the auxiliary programs 42 cause the browser 43 to display the web page provided by the EWS 23, and also render clickable the setting check button 543 for checking the settings. When the user has clicked the setting check button 543 via the user I/F 13, the auxiliary programs 42 obtain the setting information from the printer 2 in substantially the same procedure as T42 to T43, and perform a display process to display a check screen configured to display the obtained setting information. Specifically, for instance, the auxiliary programs 42 cause the display 13a to display a setting check screen 58 shown in FIG. 9. The setting check screen 58 displays thereon an OK button 581 for returning to the startup screen 54, as well as information based on the obtained setting information. The information displayed on the setting check screen 58 is not limited to the changed setting values, but includes all setting values for the print setting options. On the setting check screen 58 shown in FIG. 9, only the setting values for the print setting options are displayed among the setting information. However, other information set for the printer 2 may be displayed. Thus, in the illustrative embodiment, the user is allowed to check the settings set in the printer 2 via browser 43, by displaying the setting check screen 58 on the display 13a.

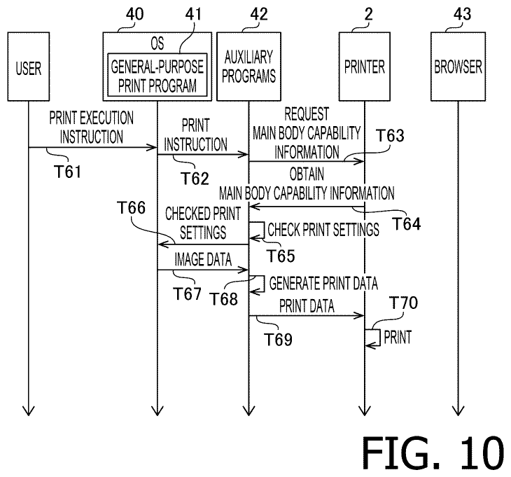

Subsequently, an explanation will be provided of a procedure of operations and processes by the individual programs in response to acceptance of a user operation to provide a print execution instruction, with reference to a sequence diagram shown in FIG. 10. The print execution instruction from the user may be input directly to the general-purpose print program 41, or may be input to the browser 43 or an application 44 and then output from the browser 43 or the application 44 to the general-purpose print program 41.

Based on the print execution instruction from the user (T61), the general-purpose print program 41 activates the auxiliary programs 42 and sends a request for processing corresponding to the print execution instruction to the auxiliary programs 42 (T62). In T62, the auxiliary programs 42 receive from the general-purpose print program 41 information on the print settings that were configured when the general-purpose print program 41 received the print execution instruction. Further, in T62, the general-purpose print program 41 may pass image data representing an image to be printed to the auxiliary programs 42.

In response to receiving a print instruction, the auxiliary programs 42 send a request for information on main body capabilities to the printer 2 (T63). The auxiliary programs 42 then obtain information on the main body capabilities from the printer 2 (T64). For instance, the information on the main body capabilities includes, but is not limited to, information on image processing executable by the printer 2. Based on the obtained information on the main body capabilities, the auxiliary programs 42 check the information on the print settings received in T62 (T65). For instance, in T65, the auxiliary programs 42 check whether there is any discrepancy between the print settings and the main body capabilities of the printer 2. Further, the auxiliary programs 42 pass the checked information on the print settings to the general-purpose print program 41 (T66).

The auxiliary programs 42 may change the print settings and pass the changed print settings in T66 according to results of the checking in T65. For instance, if the print settings received in T62 include information on particular image processing that is preferred to be performed by the printer 2 rather than by general-purpose print program 41 or the auxiliary programs 42, the auxiliary programs 42 may change the received print settings to settings from which the particular image processing is excluded. In such a case, the auxiliary programs 42 may store the information on the changed print settings (i.e., the print settings from which the particular image processing is excluded), thereby enabling the auxiliary programs 42 to pass the information on the changed print settings to the printer 2 in a later step. In this case, the auxiliary programs 42 may pass the information on the changed print settings to the general-purpose print program 41 in T66.

The general-purpose print program 41 generates intermediate image data by converting a format of image data representing a target image to be printed into a format of intermediate image data using the print settings received from the auxiliary programs 42, and then passes the generated intermediate image data to the auxiliary programs 42 (T67). The applications 44 include various types of image data. The general-purpose print program 41 converts the image data to be printed into intermediate image data suitable for generating print data. If the image data to be printed is suitable for generating print data, generating the intermediate image data may be omitted. In this case, the image data to be printed may be used as intermediate image data. The intermediate image data is, for instance, XPS data.

The auxiliary programs 42 perform rasterization based on the intermediate image data received in T67 and generate print data representing the target image to be printed (T68). The print data generated in T68 is data in a format usable for printing by the printer 2, for instance, PDL data specific to the model of the printer 2.

When the processed intermediate image data is rasterized by the auxiliary programs 42 compatible with the printer 2, the rasterization is achieved with a higher degree of freedom and it is more likely that print data suitable for printing by the printer 2 is generated than when rasterized by the general-purpose print program 41. The print data generated by the auxiliary programs 42 may be in a format usable for printing by printers other than the model of the printer 2.

The auxiliary programs 42 transmit the print data generated in T68 to the printer 2 together with a print command for instructing the printer 2 to perform printing (T69). When there is image processing that has been determined in T65 to be performed by the printer 2, the auxiliary programs 42 generate a print command that includes information on the image processing. The auxiliary programs 42 may further provide a notification that the transmission of the print data has been completed to the general-purpose print program 41.

The printer 2, which has received the print data and the print command, performs printing of the target image represented by the print data based on the received print command (T70). Thus, a printed material is generated.

Instead of the auxiliary programs 42 generating the print data, the general-purpose print program 41 may generate the print data. For instance, the auxiliary programs 42 may pass the intermediate image data received in T67 and information on printing to be executed to the general-purpose print program 41. Then, the general-purpose print program 41 may rasterize the processed intermediate image data to generate the print data. In this case, the general-purpose print program 41 may pass the generated print data to the auxiliary programs 42. In response to receiving the print data from the general-purpose print program 41, the auxiliary programs 42 send the received print data to the printer 2 together with the print command for instructing the printer to perform printing.

The print data generated by the general-purpose print program 41 is print data (e.g., PWG Raster data or PDF data) in a format usable for printing by various types of printers. If rasterization is performed by the general-purpose print program 41, it results in a smaller amount of processing by the auxiliary programs 42, thereby avoiding an increase in processing time, and reducing a program size of the auxiliary programs 42.

The general-purpose print program 41 may send the print data and the print command to the printer 2. Namely, the auxiliary programs 42 may pass the generated print data to the general-purpose print program 41, to be sent from the PC 1 with the printer 2 as a destination. In this case, the general-purpose print program 41 may send to the printer 2 the print data received from the auxiliary programs 42.

As described in detail above, in the illustrative embodiment, when the OS 40 has accepted an activation instruction to activate the auxiliary programs 42, i.e., when the user has clicked the “Start Application” button 532 displayed on the printer screen 53 (see FIG. 4) via the user I/F 13, the auxiliary programs 42 obtain connection information of the printer 2 from the OS 40, thereby enabling the PC 1 to access the EWS 23 of the printer 2 using the URL information based on the obtained connection information and display the web page provided by the EWS 23. This allows the user to view the web page provided by the EWS 23 of the printer 2 by simply performing an operation of inputting the activation instruction which is separate from a print instruction and is previously prepared in the OS 40, without having to enter the address of the printer 2 or perform an operation to activate a print application for displaying the web page provided by the EWS 23.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential alternatives, modifications, or variations according to aspects of the present disclosure are provided below.

For instance, the device connected with the PC 1 is not limited to the printer 2, but may be any device (e.g., multi-function peripherals, copiers, and fax machines) having a printing function. The number of printers 2 connected with the PC 1 is not limited to the example (i.e., one) shown in the relevant drawings, but may be two or more.

In the aforementioned illustrative embodiment, the PC 1 is configured with a notebook type personal computer. However, the PC 1 may be configured with a desktop type personal computer. In this case, the PC 1 may have interfaces connectable with devices (specifically, for instance, a keyboard, a mouse, and a display) that implement the functions of the user I/F 13. In another instance, the PC 1 may be configured with a smartphone or a tablet computer.

When the browser 43 is unable to access the EWS 23 or when the browser 43 accesses the EWS 23 of the printer 2 and makes a request for web page data (T24), if the password entered via the user I/F 13 does not match the password indicated by the password information 25, the auxiliary programs 42 may be configured to provide an error notification via the startup screen 54 as shown in FIG. 5.

In the aforementioned illustrative embodiment, only the printing operation has been described in detail as the operation by the auxiliary programs 42. However, the auxiliary programs 42 may further have other roles. Examples of the program to perform the processing in the aforementioned illustrative embodiment are not limited to the auxiliary programs 42, but may include any program configured to accept instructions from the OS 40 or the general-purpose print program 41 when printing is performed using the general-purpose print program 41. For instance, a print workflow application (Print workflow) whose specifications have been published by Microsoft Corp. may be included in the examples of the program to perform the processing in the aforementioned illustrative embodiment.

Practicable examples of the execution timing for executing the auxiliary programs 42 are not limited to the example in the aforementioned illustrative embodiment. For instance, the auxiliary programs 42 may be executed in response to a direct execution instruction from the OS 40. In another instance, the auxiliary programs 42 may be resident programs. In this case, the auxiliary programs 42 may perform the aforementioned operations in response to receiving execution commands.

In any flowchart disclosed in the aforementioned illustrative embodiment, a plurality of processes in a plurality of any steps may be arbitrarily changed in the execution order thereof or may be executed in parallel as long as there is no inconsistency in the processing results.

The processing disclosed in the aforementioned illustrative embodiment may be performed by one or more CPUs, one or more hardware elements such as ASICs, or a combination of at least two selected therefrom. The processing disclosed in the aforementioned illustrative embodiment may be implemented in various aspects such as a non-transitory computer-readable storage medium storing computer-readable instructions (e.g., programs) for performing the processing, or a method for performing the processing.

The following shows examples of associations between elements illustrated in the aforementioned illustrative embodiment(s) and modification(s), and elements claimed according to aspects of the present disclosure. For instance, the PC 1 may be an example of an “information processing device” according to aspects of the present disclosure. The CPU 11 may be an example of a “computer” according to aspects of the present disclosure. The controller 10 may be an example of a “controller” according to aspects of the present disclosure. The memory 12 may be an example of a “non-transitory computer-readable storage medium” according to aspects of the present disclosure, and may be an example of a “memory” according to aspects of the present disclosure. The display 13a may be an example of a “display” according to aspects of the present disclosure. The auxiliary programs 42 may be an example of “computer-readable instructions” according to aspects of the present disclosure. The general-purpose print program 41 may be an example of a “general-purpose print program” according to aspects of the present disclosure. The browser 43 may be an example of a “web browser” according to aspects of the present disclosure. The browser 43 and the applications 44 may be included in examples of an “application program” according to aspects of the present disclosure. The printer 2 may be an example of a “particular printer” according to aspects of the present disclosure. The EWS 23 may be an example of a “web server” according to aspects of the present disclosure.

What is claimed is:

1. A non-transitory computer-readable storage medium storing computer-readable instructions that are executable by a computer of an information processing device and compatible with a particular printer, the computer-readable instructions supporting a general-purpose print program incorporated in advance in an operating system of the information processing device, the computer-readable instructions being configured to, when executed by the computer, cause the information processing device to:
in response to receiving a request for processing from the general-purpose print program of the operating system when the operating system has accepted an activation instruction to activate the computer-readable instructions compatible with the particular printer with the particular printer selected, obtain connection information from the operating system, the connection information indicating a connection destination to which the particular printer is connected; and
perform, using the obtained connection information, a display process to display a web page provided by a web server embedded in the particular printer, the web server being configured to accept settings for the particular printer via the web page.

2. The non-transitory computer-readable storage medium according to claim 1,
wherein the computer-readable instructions are further configured to, when executed by the computer, cause the information processing device to:
perform, in the display process, activating a web browser incorporated in the information processing device and passing the obtained connection information to the activated web browser, thereby displaying via the web browser the web page provided by the web server of the particular printer.

3. The non-transitory computer-readable storage medium according to claim 1,
wherein the computer-readable instructions have a browser function and are further configured to, when executed by the computer, cause the information processing device to:
perform, in the display process, accessing the web server of the particular printer using the obtained connection information, receiving the web page from the web server, and displaying the received web page, using the browser function.

4. The non-transitory computer-readable storage medium according to claim 1,
wherein the computer-readable instructions are further configured to, when executed by the computer, cause the information processing device to:
in response to receiving the request for processing from the general-purpose print program of the operating system when the operating system has accepted the activation instruction to activate the computer-readable instructions compatible with the particular printer with the particular printer selected, accept a selection of whether to display the web page, before performing the display process;
perform the display process in response to accepting a selection to display the web page; and
not perform the display process in response to accepting a selection not to display the web page.

5. The non-transitory computer-readable storage medium according to claim 1,
wherein the computer-readable instructions are further configured to, when executed by the computer, cause the information processing device to:
in response to receiving the request for processing from the general-purpose print program of the operating system when the operating system has accepted the activation instruction to activate the computer-readable instructions compatible with the particular printer with the particular printer selected, accept a display instruction to display settings configured for the particular printer, after performing the display process; and
in response to accepting the display instruction, access the particular printer using the obtained connection information, obtain setting data indicating the settings configured for the particular printer, and display the settings indicated by the obtained setting data.

6. The non-transitory computer-readable storage medium according to claim 1,
wherein the computer-readable instructions are further configured to, when executed by the computer, cause the information processing device to:
in response to receiving the request for processing from the general-purpose print program of the operating system when the operating system has accepted the activation instruction to activate the computer-readable instructions compatible with the particular printer with the particular printer selected, access the particular printer using the obtained connection information, obtain first setting data indicating first settings configured for the particular printer, and store the obtained first setting data in a memory of the information processing device, before performing the display process; and
after performing the display process, perform a comparison process that comprises accessing the particular printer using the obtained connection information, obtaining second setting data indicating second settings configured for the particular printer, extracting differences between the second settings indicated by the obtained second setting data and the first settings indicated by the stored first setting data, and displaying the extracted differences.

7. The non-transitory computer-readable storage medium according to claim 6,
wherein the computer-readable instructions are further configured to, when executed by the computer, cause the information processing device to:
after performing the display process, accept a check instruction to check settings configured for the particular printer; and
perform the comparison process in response to accepting the check instruction.

8. The non-transitory computer-readable storage medium according to claim 6,
wherein the computer-readable instructions are further configured to, when executed by the computer, cause the information processing device to:
after performing the comparison process, accept a reset instruction to reset the second settings configured for the particular printer to the first settings; and
in response to accepting the reset instruction, send a reset command to the particular printer using the obtained connection n information, thereby causing the particular printer to reset the second settings configured for the particular printer to the first settings indicated by the stored first setting data.

9. The non-transitory computer-readable storage medium according to claim 6,
wherein the computer-readable instructions are further configured to, when executed by the computer, cause the information processing device to:
after performing the comparison process, accept a redisplay instruction to redisplay the web page provided by the web server of the particular printer; and
reperform the display process in response to accepting the redisplay instruction.

10. The non-transitory computer-readable storage medium according to claim 1,
wherein the computer-readable instructions are further configured to, when executed by the computer, cause the information processing device to:
in response to receiving a request for processing from the general-purpose print program of the operating system when a print instruction to cause the particular printer to print an image has been output from an application program incorporated in the information processing device to the general-purpose print program, obtain image data representing the image from the general-purpose print program and send to the particular printer a print command based on the obtained image data.

11. An information processing device comprising:
a display; and
a controller comprising:
a computer; and
a non-transitory computer-readable storage medium storing a general-purpose print program incorporated in advance in an operating system of the information processing device, and computer-readable instructions that are compatible with a particular printer and support the general-purpose print program, the computer-readable instructions being configured to, when executed by the computer, cause the controller to:
in response to receiving a request for processing from the general-purpose print program of the operating system when the operating system has accepted an activation instruction to activate the computer-readable instructions compatible with the particular printer with the particular printer selected, obtain connection information from the operating system, the connection information indicating a connection destination to which the particular printer is connected; and
perform, using the obtained connection information, a display process to display on the display a web page provided by a web server embedded in the particular printer, the web server being configured to accept settings for the particular printer via the web page.

12. A method implementable by a computer executing computer-readable instructions on an information processing device, the computer-readable instructions being compatible with a particular printer and supporting a general-purpose print program incorporated in advance in an operating system of the information processing device, the method comprising:
obtaining connection information from the operating system in response to receiving a request for processing from the general-purpose print program of the operating system when the operating system has accepted an activation instruction to activate the computer-readable instructions compatible with the particular printer with the particular printer selected, the connection information indicating a connection destination to which the particular printer is connected; and
performing, using the obtained connection information, a display process to display on the display a web page provided by a web server embedded in the particular printer, the web server being configured to accept settings for the particular printer via the web page.
